(19) United States
(12) Patent Application Publication
(10) Pub. No.: US 2010/0236372 A1
(43) Pub. Date: Sep. 23, 2010

(54) BLADE ASSEMBLY AND METHOD FOR MAKING CUT FOOD PRODUCTS

(75) Inventors: Fabrice DESAILLY, Vimy (FR); David M. RAWLINGS, Othello, WA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: McCain Foods Limited, Florenceville (CA)

(21) Appl. No.: 12/727,718

(22) Filed: Mar. 19, 2010

Related U.S. Application Data
(60) Provisional application No. 61/161,900, filed on Mar. 20, 2009.

(51) Int. Cl. B26D 1/03; A23P 1/10

(52) U.S. Cl. 83/857; 83/858; 426/518

(57) ABSTRACT

A blade assembly includes a number of wave-shaped blades arranged substantially parallel to each other, and spaced laterally from each other. The wave-shaped blades are secured to a support. Each wave-shaped blade includes a number of alternating blade peaks and blade troughs. Each blade peak has a maximum, and each blade trough has a minimum. An intermediate portion of the wave-shaped blade is located between the maximum and the minimum of each adjacent blade peak and blade trough. A number of sectioning blades are secured to the support and arranged substantially transverse to the wave-shaped blades. The sectioning blades are aligned with the intermediate portions of the wave-shaped blades. A method of making a cut food product from a starting food product is also disclosed.

### CROSS-REFERENCE TO RELATED APPLICATIONS

This application claims priority from U.S. Provisional Patent Application 61/161,900, filed on Mar. 20, 2009, which is incorporated herein by reference in its entirety.

### FIELD

The specification relates to blade assemblies for making cut food products. More particularly, the specification relates to blade assemblies comprising a plurality of wave-shaped blades.

### INTRODUCTION

The discussion in the following paragraph is not an admission that any information discussed therein is prior art or part of the common general knowledge of persons skilled in the art.

U.S. Pat. No. 7,096,771 discloses a cutter blade assembly that presents a sequential series of perpendicularly oriented cutting knife arrays which are attached to a frame. A first set of cutting knives is comprised of knives that are generally scalloped-shaped. A second set of cutting knives is comprised of knives that are generally straight and are connected in general perpendicular orientation to the first set of strip knives. When a vegetable product such as a potato is forced through the cutter blade assembly, the first set of knives cuts the potato into a scalloped shaped slab. The second set of knives then cuts the slab into a scoop shaped potato piece emulating a portion of a cut stalk of celery.

### SUMMARY

The following introduction is provided to introduce the reader to the more detailed discussion to follow. The introduction is not intended to limit or define the claims.

According to one broad aspect, a blade assembly is provided. The blade assembly comprises a plurality of wave-shaped blades secured to a support. The wave-shaped blades are arranged substantially parallel to each other, and spaced laterally from each other. Each wave-shaped blade comprises a plurality of alternating blade peaks and blade troughs. Each blade peak has a maximum, and each blade trough has a minimum. An intermediate portion extends between the maximum and the minimum of each adjacent blade peak and blade trough. A plurality of sectioning blades are secured to the support and are arranged substantially transverse to the wave-shaped blades. The sectioning blades are aligned with the intermediate portions of the wave-shaped blades.

In some examples, each intermediate portion has a central portion, and the sectioning blades are aligned with the central portions. The central portion may comprise one third of a length of the intermediate portion. Each central portion may have a mid-point, and the sectioning blades may be aligned with the mid-point. Each central portion may be straight.

In some examples, the sectioning blades are straight.

In some examples, the wave-shaped blades extend along a central axis, and the sectioning blades extend at an angle of between 45 degrees and 135 degrees to the central axis.

In some examples, the blade assembly, further comprises a plurality of the supports for supporting the wave-shaped blades and the sectioning blades.

In some examples, the wave-shaped blades are arranged in a plurality of pairs, and the pairs are spaced longitudinally apart. In some examples, the central axis of each sectioning blade is spaced longitudinally from the central axis of each wave-shaped blade.

In some examples, each blade peak is a smooth curve, and each trough is a smooth curve. Each wave-shaped blade may have an absence of cusps.

According to another broad aspect, a blade assembly for making cut food products from a starting food product is provided. The blade assembly comprises at least one pair of wave-shaped blades secured to a support. The wave-shaped blades are arranged substantially parallel to each other and spaced laterally from each other. Each wave-shaped blade comprises at least one blade peak and at least one blade trough adjacent the at least one blade peak. The pair of wave-shaped blades are configured to cut the starting food product into a slab having at least one slab peak and a least one slab trough adjacent the at least one slab peak. The blade assembly further comprises at least one sectioning blade secured to the support. The sectioning blade is positioned to cut the slab such that one of the cut food products is formed for each slab peak and another of the cut food products is formed for each slab trough.

In some examples, the blade peak has a maximum, the blade trough has a minimum, and an intermediate portion is defined between the maximum and the minimum.

The sectioning blade may be aligned with the intermediate portion of the wave-shaped blades. In some further examples, each intermediate portion has a central portion, and the sectioning blades are aligned with the central portions. The central portion may comprise one third of a length of the intermediate portion. Each central portion may be straight.

In some examples, each wave-shaped blade comprises a plurality of blade peaks and a plurality of blade troughs, and the pair of wave-shaped blades is configured to cut the food product into a slab having a plurality of slab peaks and a plurality of slab troughs.

In some examples, the blade assembly comprises a plurality of sectioning blades positioned to cut the slab such that a cut food product is formed for each slab peak and slab trough.

In some examples, the blade peak is a smooth curve, and the blade trough is a smooth curve.

According to another broad aspect, a method of making cut food products from a starting food product is provided. The method comprises cutting the starting food product into at least one slab. The slab comprises at least one slab peak and at least one slab trough. The slab peak has a slab peak maximum, and the slab trough has a slab trough minimum, and an intermediate slab portion is between the slab peak maximum and the slab peak minimum. The method further comprises cutting the slab at the intermediate slab portion such that one of the cut food products is formed from each slab peak and another of the cut food products is formed from each slab trough.

In some examples, step a) comprises passing the starting food product through a pair of wave-shaped blades. Each wave-shaped blade may comprise at least one blade peak and at least one blade trough adjacent the at least one blade peak.

In some examples, step b) comprises passing at least one of the starting food product and the slab through at least one sectioning blade positioned transverse to the wave-shaped blades.

In some examples, step a) comprises cutting the food product into at least one slab, wherein the slab comprising a series of slab peaks and slab troughs. Further, step b) comprises cutting each slab at each intermediate portion.

In some examples, each intermediate portion has a central portion comprising one third of a length of the intermediate slab portion, and step b) comprises cutting the slab at the central portion.

### DRAWINGS

Examples will be described below with reference to the following figures:

FIG. 1 is a partial perspective schematic illustration of a hydraulic cutting assembly;

FIG. 2 is a perspective illustration of a blade assembly used in the cutting assembly of FIG. 1;

FIG. 3 is a top plan view of the blade assembly of FIG. 2;

FIG. 4 is an enlarged view of the region shown in circle 4 in FIG. 3;

FIGS. 5A to 5C are elevation views of alternative embodiments of a wave-shaped blade;

FIG. 6 is a schematic perspective illustration of a starting food product being cut into a plurality of slabs; and

FIG. 7 is a schematic perspective illustration of a slab being cut into a plurality of cut food products.

### DESCRIPTION OF VARIOUS EXAMPLES

Various apparatuses or methods will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an example of any claimed invention.

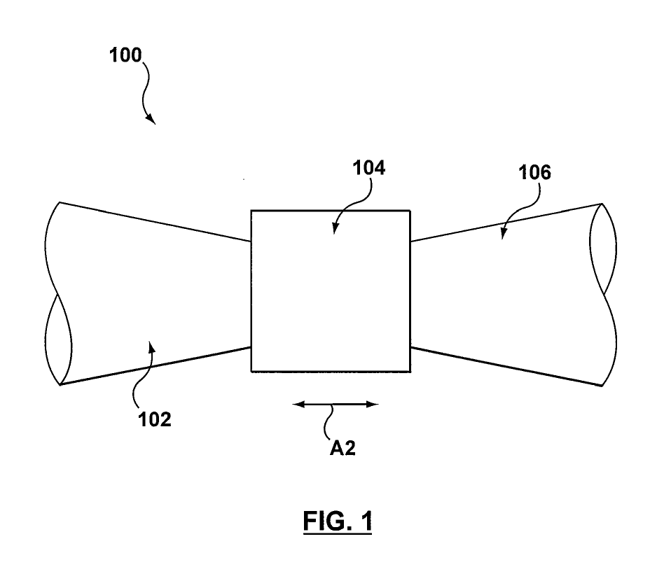

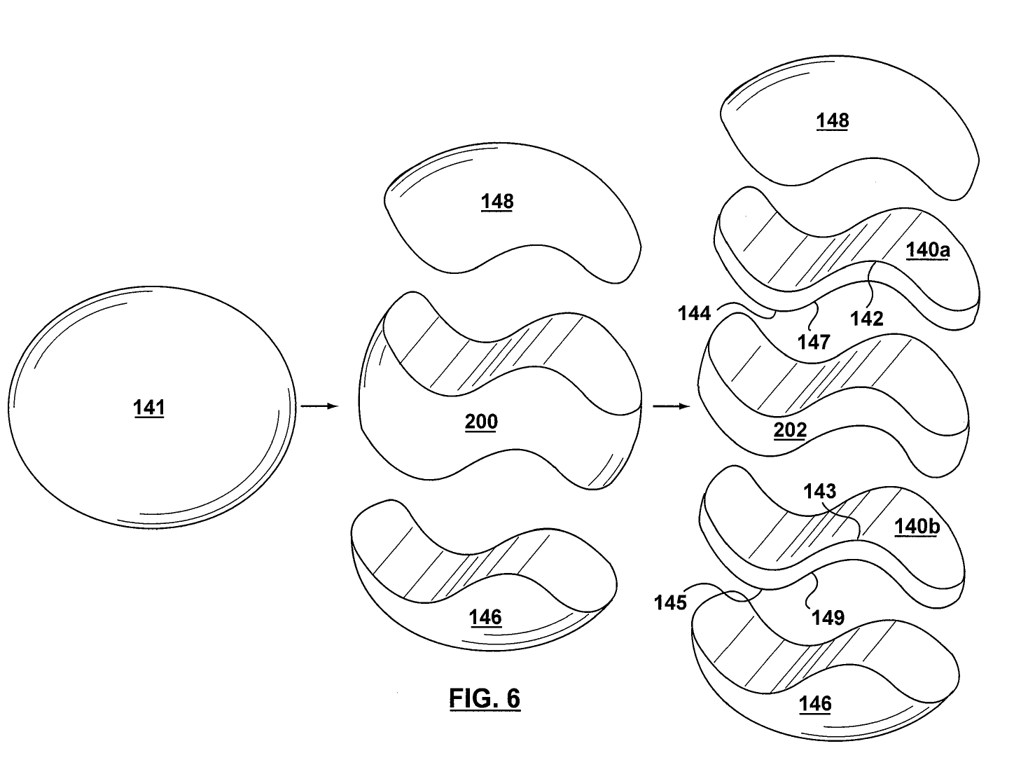

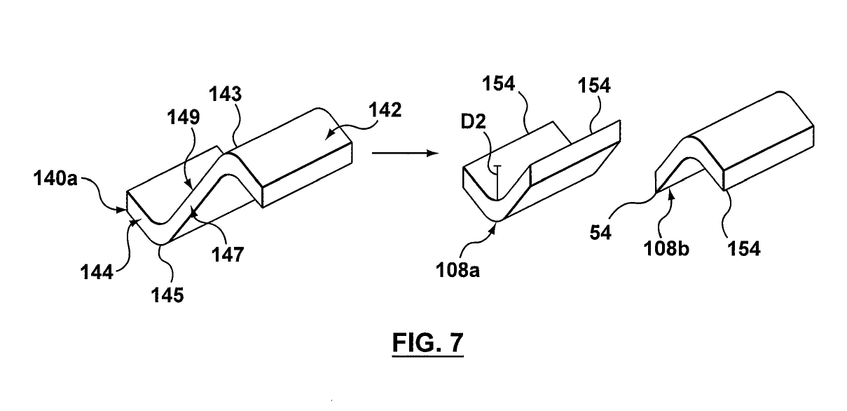

Referring to FIG. 1, a partial schematic representation of an exemplary hydraulic cutting assembly 100 is shown. The hydraulic cutting assembly comprises a nozzle gun 102, and a cutter blade assembly 104. Nozzle gun 102 may be any suitable nozzle gun, and serves to align a starting food product; such as whole potatoes, and accelerate the starting food product into the blade assembly 104. It will be appreciated that the starting food product may be any other type of food product to be cut, including without limitation sweet potatoes, turnip, and celeriac. The starting food product 141 (a potato is shown in FIG. 6 by way of example) enters the cutter blade assembly 104, and a cut food product 108 (shown in FIG. 7) exits the cutter blade assembly into outlet 106.

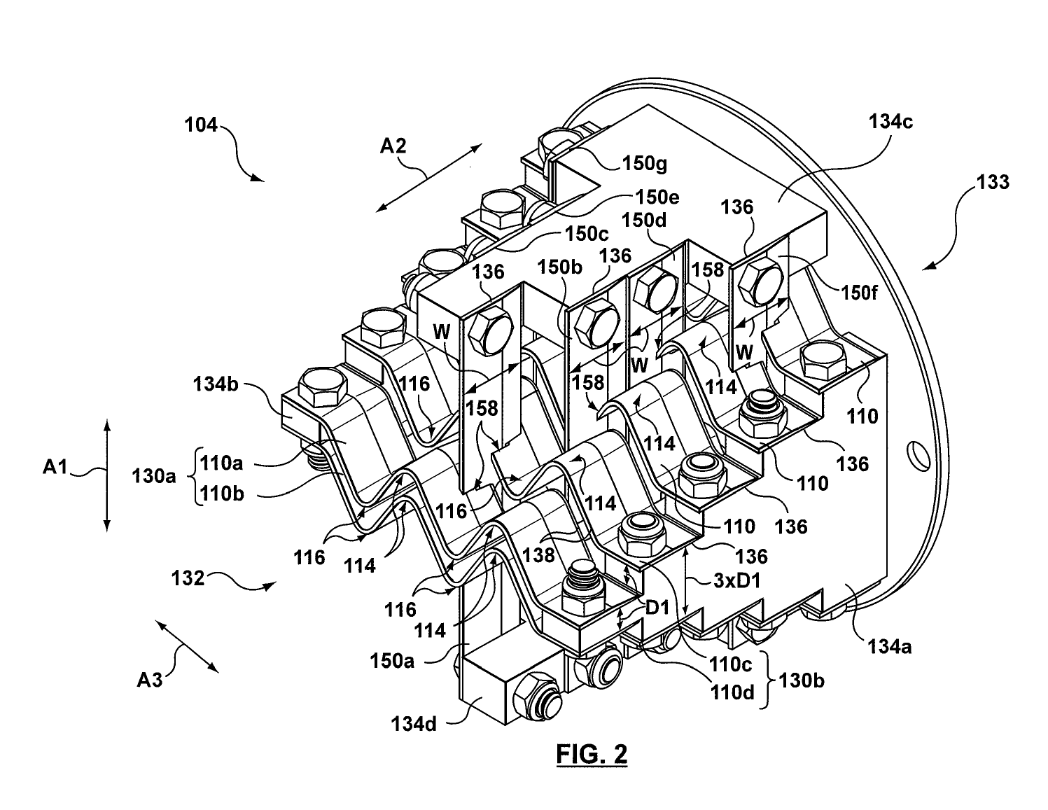

An exemplary embodiment of a blade assembly 104 is shown in FIGS. 2-4. The blade assembly 104 is configured to cut a starting food product 141 (shown in FIG. 6), such as a potato, into a cut food 108 product that is generally scoop shaped, as shown in

FIG. 7. The scoop shaped food product may optionally then be cooked, and may be used for scooping or dipping.

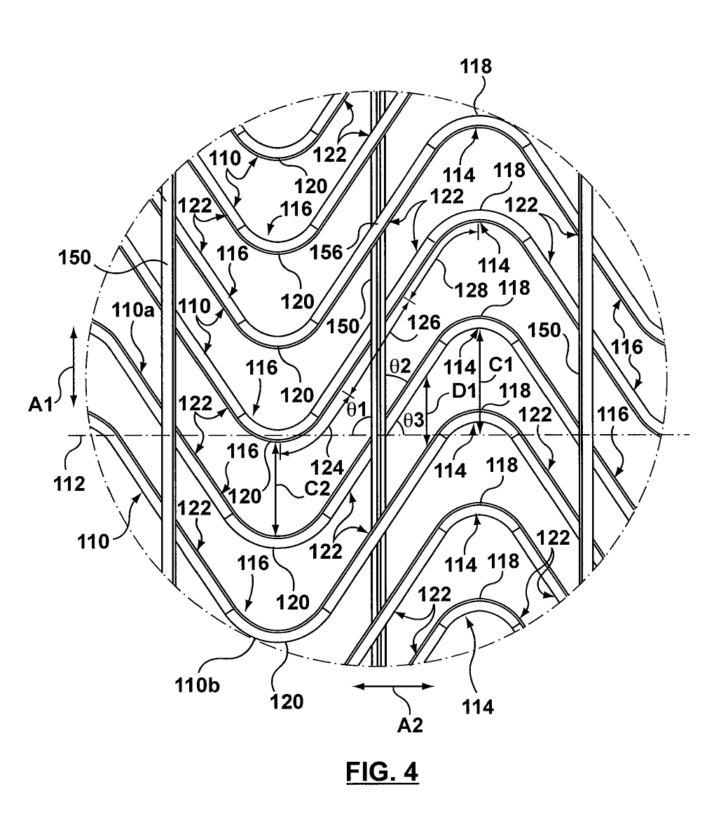

Referring to FIGS. 2-4, cutter blade assembly 104 includes a number of wave shaped blades 110. Each wave shaped blade 110 extends along a central axis 112, as shown in FIG. 4. For simplicity, only the central axis 112 of wave-shaped blade 110a is shown in FIG. 4. Each wave shaped blade 110 includes a number of alternating blade peaks 114, and blade troughs 116. For simplicity, not all blade peaks and blade troughs have been labeled in all figures. In the example shown, each wave-shaped blade 110 has two blade peaks 114, and two blade troughs 116. In alternative embodiments, each wave-shaped blade 110 may include only one blade peak and only one blade trough, or more than two blade peaks and more than two blade troughs. Further, in alternative embodiments, a given wave-shaped blade may include an unequal number blade of peaks and blade troughs. For example, a given blade may include two blade peaks and three blade troughs.

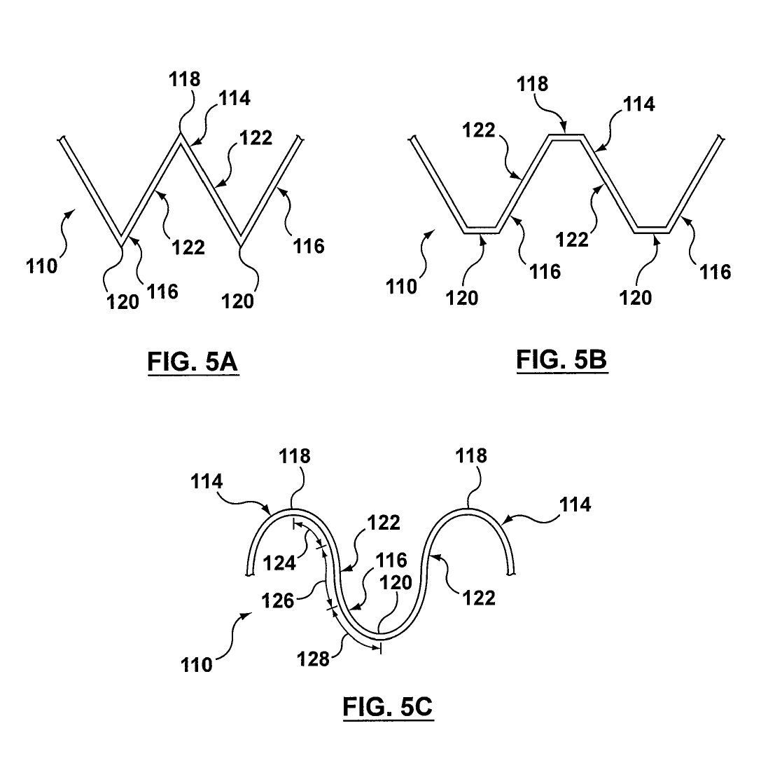

In the embodiment shown in FIGS. 2 to 4, each blade peak 114 is a substantially smooth curve, and each blade trough 116 is a substantially smooth curve, without any cusps or corners. That is, each blade peak 114 and each blade trough 116 is absent any cusps or corners. However, in alternative embodiments, the blade peaks 114 and/or blade troughs 116 may include plateaus or corners. For example, the blade peaks 114 may be shaped as an inverted V, and the blade troughs 116 may be shaped as a V, as shown in FIG. 5A. Alternatively, the wave-shaped blade 110 may have plateaued peaks and troughs, as shown in FIG. 5B.

In the embodiment shown, the blade peaks 114 and blade troughs 116 are essentially mirror images of each other. That is, the blade peaks are 114 of the same shape and size as the blade troughs 116. Further, in the example shown, the blade peaks 114 have substantially the same shape as each other blade peak, and the blade troughs 116 have substantially the same shape as each other blade trough. In alternative embodiments, the blade peaks 114 and blade troughs 116 may not be mirror images of each other. Further, particular blade peaks 114 may have different shapes than other blade peaks, and particular blade troughs 116 may have different shapes than other blade troughs.

Each blade peak 114 has a maximum 118, and each blade trough 116 has a minimum 120 (shown in FIG. 4). The maximum 118 of a blade peak 114 is the portion of the blade peak having a perpendicular distance C1 furthest from central axis 112 in one direction. The minimum 120 of a blade trough 114 is the portion of the blade trough spaced furthest by perpendicular distance C2 from central axis 112 in the other direction. In the example shown, the maximums 118 and the minimums 120 are at smoothly curved portions of the blade peaks 114 and blade troughs 120, respectively. Accordingly, the maximums 118 are maximum points, and the minimums 120 are minimum points (i.e. the points wherein the slope of the blade is parallel to the central axis 112 of the blade). Similarly, in embodiments wherein the blade peaks 114 are inverted V-shaped, and the blade troughs 116 are V-shaped, as shown in FIG. 5A, the maximums 118 are maximum points, and the minimums 120 are minimum points. In alternative embodiments, however, the maximums 118 and minimums 120 may be at a flat portion of the blade peaks 114 and blade troughs 116, respectively, as shown in FIG. 5B. In such examples, the maximum 118 may be a maximum region, and the minimum 120 may be a minimum region.

Continuing to refer to FIG. 4, an intermediate portion 122 is defined between the maximum 118 and the minimum 120 of each adjacent blade peak 114 and blade trough 116. Preferably, the intermediate portions 122 each include three portions: a lower portion 124, a central portion 126, and an upper portion 128 (for simplicity, shown only once in FIG. 4). The lower portion 124 extends upwardly from the minimum 120 of a given blade trough 116, and the upper portion 128 extends downwardly from the maximum 118 of an adjacent blade peak 114. The central portion 126 is located between the lower portion 124 and the upper portion 128. In the embodiment shown, the lower portion 124, central portion 126, and upper portion 128 each occupy approximately one-third of the length of the intermediate portion 122.

In the embodiment shown, each central portion 126 is substantially straight. Further, each lower portion 124 and each upper portion 128 is curved. In alternate examples, the central portions 126 may be curved, as shown in FIG. 5C.

Preferably, each central portion 126 is at an angle θ3 of between about 67.5 degrees and about 45 degrees with respect to each central axis. For example, each central portion may be at an angle θ3 of about 56.25 degrees with respect to each central axis. In alternative embodiments, different angles may be used.

Continuing to refer to FIGS. 2 to 4, in the blade assembly 104, the wave shaped blades 110 are arranged substantially parallel to each other. That is, central axes 112 are substantially parallel to each other.

Further, in the blade assembly shown, the wave-shaped blades 110 are spaced laterally apart from each other. That is, the wave-shaped blades 110 are spaced apart in a direction perpendicular to central axes 112 (indicated by arrow A1).

Referring to FIG. 2, the wave shaped blades 110 are arranged in pairs 130, and the pairs 130 are spaced longitudinally apart from each other (in a direction indicated by arrow A2). More particularly, in the example shown, the central axes of a given blade pair 130 are spaced longitudinally apart from the central axes of an adjacent pair. That is, in the example shown, the edges 138 of pair 130a are longitudinally aligned with edges 138 of pair 130b. However, the central axes of pair 130a are spaced longitudinally apart from the central axes of pair 130b. It will be appreciated that in alternate examples, the edges 138 of a given pair may be spaced longitudinally apart from the edges 138 of an adjacent pair, or the edges 138 of a given pair may overlap with the edges 138 of an adjacent pair. Furthermore, in other alternate examples, the wave shaped blades 110 may not be arranged in pairs 130, and may not be spaced longitudinally apart from each other.

Continuing to refer to FIG. 2, in the embodiment shown, the first pair 130a of wave-shaped blades 110 is located at a first longitudinal end 132 of the blade assembly 104. Preferably, the first end 132 of the blade assembly 104 is the downstream end. The wave-shaped blades 110a, 110b of the first pair 130a are spaced laterally apart by a distance D1 (shown in FIG. 4). A second pair 130b of wave-shaped blades 110 is longitudinally spaced from the first pair 130a, such that the edges 138 of the first pair 130a are aligned with the edges 138 of the second pair 130b. Wave-shaped blade 110c of the second pair 130b is laterally spaced from wave-shaped blade 110a of the first pair 130a by a distance equal to D1. Wave-shaped blade 110d of the second pair 130b is laterally spaced from wave-shaped blade 110b of the first pair 130a by a distance equal to D1. Accordingly, the wave-shaped blades 110c, 110d of the second pair 130b are spaced laterally apart from each other by a distance equal to 3×D1. This pattern is repeated for each subsequent (i.e. spaced longitudinally) pair of wave-shaped blades 110, such that a wave-shaped blade 110 of a given pair is spaced laterally from a wave-shaped blade 110 of a subsequent pair by a distance equal to D1, and each pair of wave-shaped blades is spaced further apart laterally than the previous pair of wave-shaped blades (when looking at the cutter blade assembly from the downstream end to the upstream end).

Referring now to FIGS. 2 and 6, the wave shaped blades 110 are configured to cut a starting food product 141 into a plurality of final slabs, such as slabs 140a and 140b.

Each final slab 140a,b is preferably composed of at least one slab peak 142, at least one slab trough 144, and an intermediate slab portion 147 located between the slab peak and slab trough. For clarity, reference parts 142, 144, and 147 are only shown on final slab 140a. Further, each slab peak 142 has a slab peak maximum 143, each slab trough 144 has a slab trough minimum 145. Each intermediate slab portion 147 has a slab central portion 149. For clarity, reference parts 143, 145, and 149 are only shown on final slab 140b. For example, the first pair 130 of wave-shaped blades closest to an upstream end 133 of the blade assembly 104 will pass through a starting food product 141 and the starting food product will be cut into a first intermediate slab 200, a first end piece 146, and a second end piece 148. A subsequent wave blade pair 130 downstream of the first wave pair blade will cut the first intermediate slab 200 into final slabs 140a,b and second intermediate slab 202. A subsequent downstream wave blade pair 130 will cut the second intermediate slab 202 into two more final slabs (not shown) and a third intermediate slab (not shown), and so on until the final downstream wave blade pair 130a cut the last intermediate slab into final slabs. It will be appreciated that due to the longitudinal spacing the pairs 130 of wave-shaped blades 110, the first intermediate slab 200 may begin to be cut into the first and second final slab 140a,b before the first intermediate slab 200 is completely severed from the first and second end pieces 146, 148. It will also be appreciated that the orientation of the blade assembly 104 may be reversed, with the upstream end 133 being located downstream and the downstream end 132 being located upstream. In such an orientation, the cutting of the food product 141 will occur in a different fashion. Specifically, the final slabs will be cut from the end pieces as the food product is forced through the blade assembly, and intermediate slabs may not be produced.

In the embodiment shown in FIGS. 2 to 4, supports 134a and 134b are provided. Supports 134a and 134b are generally pyramidally shaped, and comprise a plurality of pairs mounting surfaces 136, to which the wave-shape blades 110 are mounted.

Referring back to FIGS. 2 to 4, the blade assembly 104 further includes a number of sectioning blades 150. In the embodiment shown, the sectioning blades 150 are substantially straight. However, it will be understood by those skilled in the art that the sectioning blades 150 may be curved, bent, or any other suitable shape.

In the embodiment shown, the blade assembly 104 comprises seven sectioning blades 150a to 150g. However, it will be appreciated that in alternate embodiments, the number of sectioning blades 150 may vary depending on the number of blade peaks 114 and blade toughs 116 of the wave blades 110. For example, if the wave blades 110 comprise only one blade peak 114 and one blade trough 116, only one sectioning blade 150 may be provided.

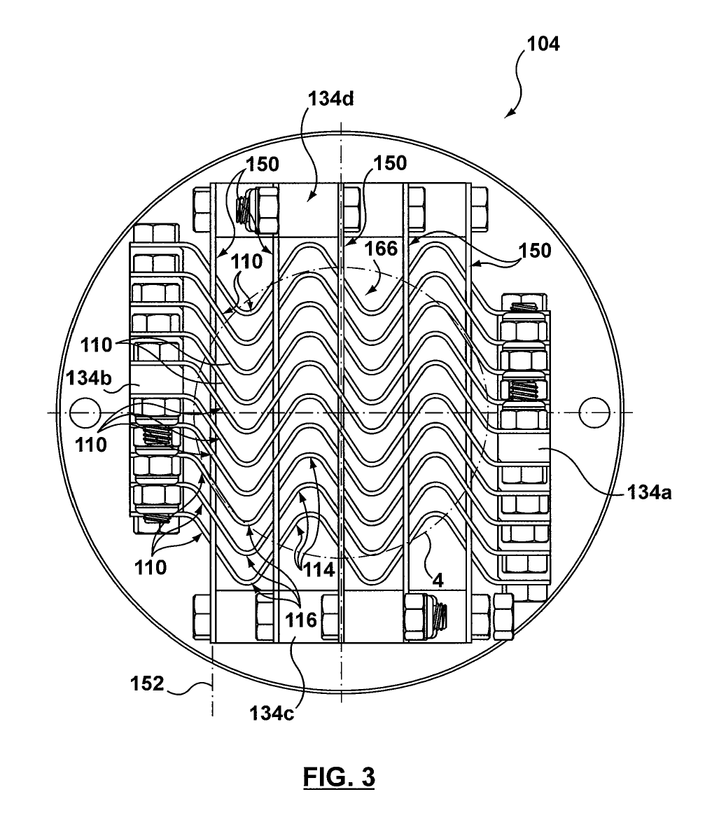

In the blade assembly 104, the sectioning blades 150 are arranged substantially transverse to the wave-shaped blades 110, and are aligned with the intermediate portions 122 of the wave shaped blades 110. As used herein, “aligned” means that, when the blade assembly 104 is viewed from above as shown in FIGS. 3 and 4, the sectioning blades 150 intersect the wave-shaped blades or a plane defined by the wave-shaped blades at intermediate portions 122.

More particularly, in the example shown, the sectioning blades 150 are at an angle θ1 with respect to central axes 112 of the wave-shaped blades, and at an angle θ2 with respect to intermediate portions 122. Angle θ1 is preferably in the range of between about 45 degrees and about 135 degrees, and more preferably, is about 90 degrees. Preferably, θ2 is in the range of between about 22.5 degrees and about 45 degrees, and more preferably, is about 33.5 degrees. In alternative embodiments, sectioning blades 150 may be oriented at any another suitable angle, provided that a given sectioning blade is not parallel or tangential to the intermediate portions 122 which it crosses. For example, sectioning blades 150 may be perpendicular to intermediate portions 122. Alternately, sectioning blades may be parallel to central axis 112 of wave-shaped blades.

An angle θ2 of between 22.5 and 45 degrees may be particularly advantageous because the resulting cut food product 108 may have substantially sharp edges 154 (shown in FIG. 7). Such sharp edges 154 may become substantially crispy when the cut food product is cooked.

As mentioned above, the sectioning blades 150 are aligned with the intermediate portions 122 of the wave shaped blades 110. In the example shown, the sectioning blades 150 are aligned with the central portions 126 of the intermediate portions 122. More particularly, in the example shown, the sectioning blades 150 are aligned with a midpoint 156 of the central portions 126 of the intermediate portions 122. In alternative embodiments, the sectioning blades 150 may be aligned with another point on the intermediate portions 122 of the wave shaped blades 110. For example, the sectioning blades may be aligned with the wave-shaped blades at the junction of the central portion 126 and the upper portion 128, or at the junction of the central portion 126 and the lower portion 124.

In the embodiment shown, each sectioning blade 150 extends across (i.e. intersects when viewed from above) each of the wave-shaped blades 110. In alternate examples, each sectioning blade 150 may extend across some of the wave-shaped blades, for example only two of the wave shaped blades.

In the blade assembly 104, the sectioning blades are preferably spaced longitudinally from the wave-shaped blades 110 (in a direction indicated by arrow A2). More particularly, in the example shown, the sectioning blades 150 are spaced from the central axes 112 of the wave-shaped blades, such that the width W (shown in FIG. 2) of each sectioning blade 150 extends between the central axes of an adjacent pair 130 of wave-shaped blades. In the example shown, the wave-shaped blades 110 includes slots 158 in which portions the sectioning blades 150 are received.

The sectioning blades of the embodiment shown will now be described with reference to FIG. 2, working from the left side of FIG. 2 to the right side thereof and in reverse order to the direction of movement of the starting food product through the blade assembly 104. A preferably single first sectioning blade 150a is positioned such that the width W thereof extends between the central axes 112 of the first pair 130a of wave-shaped blades and the central axes of the second pair 130b of wave-shaped blades. A second sectioning blade 150b and a third sectioning blade 150c are positioned such that the widths W thereof extend between the central axes of the second pair 130b of wave-shaped blades and a third pair 130c of wave-shaped blades. A fourth and a fifth sectioning blade 150d, 150e, respectively, are positioned such that the widths W thereof extend between the central axes of the third pair of wave-shaped blades (not labeled) and a fourth pair (not labeled) of wave-shaped blades. A sixth and a seventh sectioning blade 150f, 150g are positioned such that the widths W thereof extend between the central axes of the fourth pair (not labeled) of wave-shaped blades and a fifth pair (not labeled) of wave-shaped blades.

In alternative embodiments, the sectioning blades 150 may not be spaced longitudinally apart from the wave-shaped blades 110.

In the example shown, some of the sectioning blades 150 are spaced laterally apart from each other (in a direction indicated by arrow A3), and some are not (i.e. some are laterally aligned), such that each intermediate portion 122 of each wave-shaped blade is aligned with at least one sectioning blade. For example, the first sectioning blade 150a is spaced laterally apart from the second sectioning blade 150b. However, the second sectioning blade 150b is not laterally spaced apart from the fourth sectioning blade 150d.

In alternative embodiments, all of the sectioning blades 150 may be spaced laterally apart from each other, or all of the sectioning blades may be laterally aligned, depending on the configuration of the wave-shaped blades.

Accordingly, the sectioning blades 150 are positioned to cut the slabs 140 such that a cut food product is formed for each slab peak 142, and another cut food product is formed for each slab trough 144. For example, referring to FIGS. 2, 6 and 7, as the starting food product 141 passes through the pair 130 of wave blades 110 located furthest upstream, the starting food product 141 is cut into the first intermediate slab 200 and the two end pieces 146, 148. Then the upstream-most sectioning blades 150g,f pass through the first intermediate slab 200 and the two end pieces 146, 148. Subsequent sectioning blades located downstream of upstream-most sectioning blades 150g,f cut the final slabs 140a,b into cut food products 108a,b (shown in FIG. 7).

It will be appreciated that due to the longitudinal spacing of the sectioning blades 150 with respect to the wave-shaped blades 110, the sectioning blades 150 may begin to cut the slabs before the slabs are fully severed from the starting food product or from each other. That is, cutting of the starting food product into slabs, and of the slabs into cut food products, may occur at least partially simultaneously.

In the example shown, the blade assembly 104 comprises supports 134c and 134d, which support the sectioning blades. Supports 134c and 134d comprise a plurality of pairs mounting surfaces 136, to which the sectioning blades 110 are mounted in any suitable fashion, such as by fasteners.

Referring to FIGS. 1, 3, 6 and 7, in operation, the starting food product 141, such as potatoes, are aligned in the nozzle gun 102 of the hydraulic cutting assembly 100 and accelerated into the cutter blade assembly 104. As the starting food product passes from the upstream end 133 to the downstream end 132 of the cutter blade assembly 104, the starting food product is cut into the cut food products 108a,b (such as scoop-shaped potato pieces), as described above. The cut food products 108a,b exit the cutter blade assembly 104 via the outlet 106.

Referring now to FIG. 7, the resulting cut food products 108a, 108b are generally scoop shaped. In some embodiments, the cut food products 108a 108b have a depth D2 in the range of about 2 mm to about 60 mm, and preferably about 10 mm. It has been determined that if the scoop-shaped cut food product is subsequently cooked, for example deep fried, such a depth may allow for the scoop-shaped cut food product to maintain its shape during cooking. For example, some scoop-shaped cut food products may puff when deep-friend, and become pillow shaped. However, scoop-shaped cut food products of this depth may undergo reduced puffing. Further, as the final slabs 140 are cut at the intermediate portions 147 to form substantially sharp corners (i.e. having an angle of between 30 degrees and 60 degrees), the corners may become substantially crispy when deep fried. Such crispy corners may provide good organoleptic properties. Further, such crispy corners may provide strength to the scoop-shaped food product, such that when dipped into other food products, the scoop-shaped food product better resists breaking.

1. A blade assembly comprising:
a) a support;
b) a plurality of wave-shaped blades secured to the support and arranged substantially parallel to each other, the plurality of wave-shaped blades being spaced laterally from each other, each wave-shaped blade comprising:
i) a plurality of alternating blade peaks and blade troughs, each blade peak having a maximum, and each blade trough having a minimum; and
ii) an intermediate portion located between the maximum and the minimum of each adjacent blade peak and blade trough; and
c) a plurality of sectioning blades secured to the support and arranged substantially transverse to the wave-shaped blades, the sectioning blades being aligned with the intermediate portions of the wave-shaped blades.

2. The blade assembly of claim 1, wherein each intermediate portion comprises a central portion, and wherein the sectioning blades are aligned with the central portions.

3. The blade assembly of claim 2, wherein the central portion comprises one third of a length of the intermediate portion.

4. The blade assembly of claim 2, wherein the sectioning blades are aligned with a mid-point of the central portions.

5. The blade assembly of claim 2, wherein each central portion is straight.

6. The blade assembly of claim 1, wherein the sectioning blades are straight.

7. The blade assembly of claim 6, wherein the wave-shaped blades extend along a central axis, and the sectioning blades extend at an angle of between 45 degrees and 135 degrees to the central axis.

8. The blade assembly of claim 1, further comprising a plurality of the supports for supporting the wave-shaped blades and the sectioning blades.

9. The blade assembly of claim 1, wherein the wave-shaped blades are arranged in a plurality of pairs, and the pairs are spaced apart longitudinally.

10. The blade assembly of claim 1, wherein a central axis of each sectioning blade is spaced longitudinally from a central axis of each wave-shaped blade.

11. The blade assembly of claim 1, wherein each wave-shaped blade has an absence of cusps and corners.

12. A blade assembly for making a cut food product from a starting food product, the cut food product comprising at least one slab, the blade assembly comprising:
a) a support;
b) at least one pair of wave-shaped blades secured to the support and arranged substantially parallel to each other, the at least one pair of wave-shaped blades being spaced laterally from each other, each wave-shaped blade comprising at least one blade peak and at least one blade trough in an alternating arrangement, the at least one pair of wave-shaped blades configured to cut the starting food product into the at least one slab having at least one slab peak and a least one slab trough adjacent the at least one slab peak; and
c) at least one sectioning blade secured to the support, the at least one sectioning blade positioned to cut the slab such that one cut food product is formed from the slab peak and another cut food product is formed from the slab trough.

13. The blade assembly of claim 12, wherein:
a) the blade peak comprises a maximum, the blade trough comprises a minimum, and each wave-shaped blade comprises an intermediate portion located between the maximum and the minimum; and
b) the sectioning blade is aligned with the intermediate portion of the wave-shaped blades.

14. The blade assembly of claim 12, wherein each intermediate portion has a central portion, and wherein the sectioning blade is aligned with the central portions of the pair of wave-shaped blades.

15. The blade assembly of claim 14, wherein the central portion comprises one third of a length of the intermediate portion.

16. The blade assembly of claim 12, wherein each central portion is substantially straight.

17. The blade assembly of claim 12, wherein each wave-shaped blade comprises a plurality of alternating blade peaks and blade troughs, and the pair of wave-shaped blades is configured to cut the starting food product into the slab, wherein the slab has a plurality of slab peaks and a plurality of slab troughs.

18. The blade assembly of claim 14, wherein the blade assembly comprises a plurality of the sectioning blades positioned to cut the slab such that the cut food product is formed for each slab peak and slab trough.

19. The blade assembly of claim 12, wherein the blade peak comprises an absence of cusps and corners, and the blade trough comprises an absence of cusps and corners.

20. A method of making a cut food product from a starting food product, comprising:
a) cutting the starting food product into at least one slab, the slab comprising:
i) at least one slab peak and at least one slab trough, the slab peak having a slab peak maximum, and the slab trough having a slab trough minimum, and
ii) a intermediate slab portion between the slab peak maximum and the slab peak minimum; and
b) cutting the slab at the intermediate slab portion such that one cut food product is formed from each slab peak and another cut food product is formed for each slab trough.

21. The method of claim 20, wherein step a) is performed by passing the starting food product through at least one pair of wave-shaped blades, wherein each wave-shaped blade comprises at least one blade peak and at least one blade trough adjacent the at least one blade peak.

22. The method of claim 21, wherein step b) is performed by passing one of the starting food product and the slab through at least one sectioning blade positioned transverse to the wave-shaped blades.

23. The method of claim 20, wherein step a) comprises cutting the food product into at least one slab, wherein the slab comprises a series of slab peaks and slab troughs; and step b) comprises cutting each slab at each intermediate slab portion.

24. The method of claim 20, wherein each intermediate slab portion comprises a central slab portion comprising one third of a length of the intermediate slab portion, and step b) comprises cutting the slab at the central slab portion.
